(19) United States
(12) Patent Application Publication
(10) Pub. No.: US 2016/0110704 A1
(43) Pub. Date: Apr. 21, 2016

(54) Method and System of Implementing Electronic Payment via Mobile Terminal

(71) Applicant: Alibaba Group Holding Limited, Grand Cayman (KY)

(72) Inventor: Zheng Ma, Hangzhou (CN)

(73) Assignee: Alibaba Group Holding Limited

(21) Appl. No.: 14/887,121

(22) Filed: Oct. 19, 2015

(30) Foreign Application Priority Data
Oct. 20, 2014 (CN) 201410559498.5

(51) Int. Cl. G06Q 20/32

(52) U.S. Cl. CPC G06Q 20/3223

(57) ABSTRACT

A method and a system for implementing an electronic payment using a mobile terminal are disclosed. In the method, the mobile terminal exchanges payment information with an access terminal through a wireless connection, and a platform apparatus confirms a payment completion status. A user and a merchant do not need to exchange passwords, thus ensuring the security of a transaction, and a fast payment system is established, which maximizes the utilization of existing resources of the user. In addition, a linked device may further be used to implement functions as printing a transaction receipt or voucher after an electronic payment is completed to allow both the user and the merchant to possess data and records associated with the transaction, thereby ensuring the truthfulness, validity and legality of the transaction.

### CROSS REFERENCE TO RELATED PATENT APPLICATION

This application claims foreign priority to Chinese Patent Application No. 201410559498.5 filed on Oct. 20, 2014, entitled “Method and System of Implementing Electronic Payment via Mobile Terminal”, which is hereby incorporated by reference in its entirety.

### TECHNICAL FIELD

The present disclosure relates to communication technologies, and more particularly, to methods and systems of implementing an electronic payment via a mobile terminal.

### BACKGROUND

With the continuous development of the information community and the quickly increasing pace of life, fast and convenient payments have become a part of people's daily lives, work, and studies, which include, but are not limited to, restaurants, shopping, and parking, etc. Therefore, a method that achieves a quick and convenient payment can offer great convenience and high efficiency, allowing people to pay for commodities without difficulty and without the need of carrying a wallet or bank card.

Wireless technologies such as 2G, 3G and 4G mobile networks, WiFi, and Bluetooth have become increasingly mature and have gradually changed the living habits and the lifestyles of people. With advantages such as high security, low cost, high rate, low power consumption, high integrity and small volume, such technologies have satisfied the daily needs of people to a great extent. Modern payment methods, which have characteristics such as convenience, high efficiency, easy to use and user-friendly, etc., are set to replace traditional payment methods.

However, inventors of the present disclosure have noted that some existing payment methods are still dependent on and limited by wallets and bank cards, have security risks, require complex reconstruction of existing equipment, and cannot make full use of existing resources.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

An objective of the present disclosure is to provide a method and a system for implementing an electronic payment using a mobile terminal, which ensure the security of transactions and maximize the utilization of existing resources of a user without restriction.

In order to solve the aforementioned technical problems, embodiments of the present disclosure provide a method for implementing an electronic payment via a mobile terminal. In implementations, the method may include a mobile terminal establishing a wireless connection with an access terminal, and the access terminal sending payment information to the mobile terminal through the wireless connection; the mobile terminal displaying the payment information, and interacting with a payment server to complete a payment based on the payment information after receiving an input indicating user confirmation; the mobile terminal notifying the access terminal that the payment has been completed through the wireless connection, and the access terminal notifying a platform apparatus that the payment has been completed; and the platform apparatus interacting with the payment server to confirm a payment completion status of the mobile terminal.

Furthermore, embodiments of the present disclosure provide a system for implementing an electronic payment using a mobile terminal. In implementations, the system may include a mobile terminal configured to establish a wireless connection with an access terminal, display payment information that is received from the access terminal, interact with a payment server based on the payment information after receiving an input indicating user confirmation to complete a payment, and notify the access terminal that the payment has been completed through the wireless connection. The access terminal may be configured to establish the wireless connection with the mobile terminal, send the payment information to the mobile terminal through the wireless connection, and notify a platform apparatus that the payment has been completed in response to receiving a notification indicating that the payment has been completed from the mobile terminal through the wireless connection. The platform apparatus may be configured to interact with the payment server to confirm a payment completion status of the mobile terminal in response to receiving the notification indicating that the payment has been completed from the access terminal; and the payment server configured to complete processing of an electronic payment service.

Compared with the existing technologies, the embodiments of the present disclosure have the following differences and effects:

In the disclosed electronic payment method, a mobile terminal and an access terminal exchange payment information through a wireless connection, and a platform apparatus confirms a payment completion status. In an entire process of a transaction, a user and a merchant do not need to exchange passwords, thus ensuring the security of the transaction. Moreover, a fast payment system based on a wireless technology and a mobile terminal is established, which maximizes the utilization of existing resources of the user without restriction.

Furthermore, in the transaction process, a linked device may be used to implement functions such as printing a transaction receipt or voucher after the electronic payment is completed, so that both the user and the merchant can possess transaction data and records, thereby ensuring the truthfulness, validity and legitimacy of the electronic transaction process.

Furthermore, in the transaction process, only user identity information and merchant information is exchanged between the user and the merchant, thus ensuring the security of the transaction while providing convenient operations and improving user experience.

Moreover, the access terminal accesses only one mobile terminal at a time, so that the stability and security of the transaction can be ensured.

### BRIEF DESCRIPTION OF THE DRAWINGS

FIG. 1 is a flowchart of a method for implementing an electronic payment using a mobile terminal according to a first embodiment of the present disclosure.

FIG. 2 is a flowchart of a method for implementing an electronic payment using a mobile terminal according to a second embodiment of the present disclosure.

FIG. 3 is a flowchart of a method for implementing an electronic payment using a mobile terminal according to the second embodiment of the present disclosure.

FIG. 4 is a structural diagram of a system for implementing an electronic payment using a mobile terminal according to a third embodiment of the present disclosure.

FIG. 5 is a structural diagram of a system for implementing an electronic payment using a mobile terminal according to a fourth embodiment of the present disclosure.

FIG. 6 is a structural diagram of an access terminal in a system for implementing an electronic payment using a mobile terminal according to the fourth embodiment of the present disclosure.

FIG. 7 is a structural diagram of an access terminal in a system for implementing an electronic payment using a mobile terminal according to the fourth embodiment of the present disclosure.

FIG. 8 is a structural diagram of circuit modules of an access terminal in a system for implementing an electronic payment using a mobile terminal according to the fourth embodiment of the present disclosure.

FIG. 9 is a structural diagram of the example apparatuses, devices and systems described in FIGS. 4-8 in further detail.

### DETAILED DESCRIPTION

In order to enable readers to better understand the present disclosure, a number of technical details are provided in detail herein. However, one of ordinary skill in the art should understand that technical solutions recited in the appended claims of the present disclosure can be implemented even without these technical details and the technical solutions recited in the appended claims of the present disclosure can be implemented based on various changes and modifications to the following embodiments.

In order make the objectives, technical solutions, and advantages of the present disclosure more comprehensible, embodiments of the present disclosure are described in further detail hereinafter with reference to the accompanying drawings.

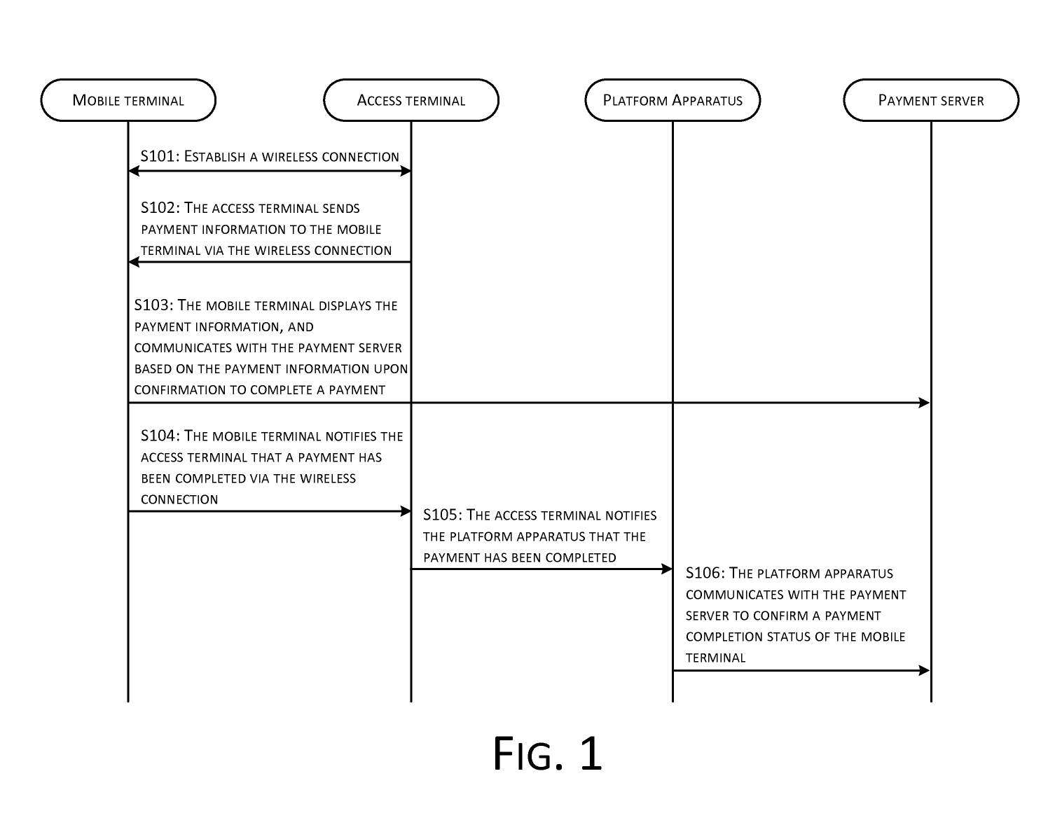

A first embodiment of the present disclosure is related to a method for implementing an electronic payment using a mobile terminal. FIG. 1 is a flowchart illustrating the method for implementing an electronic payment using a mobile terminal. As shown in FIG. 1, the method for implementing an electronic payment using a mobile terminal may include the following method blocks:

At S101, a mobile terminal establishes a wireless connection with an access terminal. It is noted that, the wireless connection may include a one-to-one wireless connection, for example, Bluetooth or Near Field Communication (“NFC”), etc., or WiFi, which may also be used in a scenario with guaranteed security, in various implementations of the present disclosure.

In an implementation, the access terminal may access only one mobile terminal at a time. The access terminal is allowed to access only one mobile terminal at a time in order to ensure the stability and security of a transaction. Moreover, it is noted that the access terminal may also access a plurality of mobile terminals at the same time in some particular application scenarios.

At S102, the access terminal sends payment information to the mobile terminal via the wireless connection.

At S103, the mobile terminal displays the payment information, communicates with a payment server based on the payment information to complete a payment in response to receiving an input indicating user confirmation.

At S104, the mobile terminal notifies the access terminal that the payment has been completed via the wireless connection.

At S105, the access terminal notifies a platform apparatus that the payment has been completed. It is noted that, the access terminal may be connected to the platform apparatus in a wired or wireless manner in various implementations of the present disclosure.

At S106, the platform apparatus interacts with the payment server to confirm a payment completion status of the mobile terminal.

The process is ended.

In the disclosed electronic payment method, a mobile terminal and an access terminal exchange payment information through a wireless connection, and a platform apparatus confirms a payment completion status. In an entire process of a transaction, a user and a merchant do not need to exchange passwords, thus ensuring the security of the transaction. Moreover, a fast payment system based on a wireless technology and a mobile terminal is established, which maximizes the utilization of existing resources of the user without restriction.

Application scenarios of the foregoing method for implementing an electronic payment using a mobile terminal mainly include an instant payment for consumption and a delayed payment for consumption.

In an instant payment for consumption, once a mobile terminal establishes a wireless connection to an access terminal, the access terminal may send related payment information to the mobile terminal.

In a delayed payment for consumption, method blocks S101 and S102 may include the following method sub-blocks:

the mobile terminal establishing a first wireless connection with the access terminal, and the access terminal recording a first time and/or a first place at which the first wireless connection takes place; and

the mobile terminal establishing a second wireless connection with the access terminal, and the access terminal recording a second time and/or a second place at which the second wireless connection takes place, and sending the payment information to the mobile terminal via the wireless connection according to information of recorded times and/or places.

It is noted that a difference in recorded times may be used for calculating a fee for parking, a fee for karaoke, etc., or a difference in recorded distances may be used for calculating a driving cost, a transportation fee, etc., according to specific application scenarios. Moreover, it is noted that, multiple wireless connections may be established according to needs in particular application scenarios, and corresponding times, places or other information are recorded. Final payment information is sent to the mobile terminal based on these pieces of information, and the number of wireless connections is not restricted to two times.

A second embodiment of the present disclosure is related to a method for implementing an electronic payment using a mobile terminal. In the second embodiment, a number of additions are made on the basis of the first embodiment.

A first addition includes additionally employing a linked device in a transaction process. More specifically, the method may further include the following method blocks:

the platform apparatus notifying the access terminal that the payment is completed, and the access terminal initiating the linked device; or

the platform apparatus notifying the access terminal that the payment has not been completed and the access terminal turning off the linked device in response to determining that the payment is not completed.

It is noted that the linked device may include a door access controller, a switch button, a printer, etc., in various implementations of the present disclosure. Apparently, in other implementations of the present disclosure, the linked device may not need to be deployed.

In a transaction process, the linked device is used to implement functions such as printing a transaction receipt or voucher after the electronic payment is successfully made, so that a user and a merchant are both able to possess transaction data and records, thereby ensuring the truthfulness, validity and legality of the electronic transaction process.

A second addition includes performing a registration using identity information of a user. More specifically, the method may further include the following method blocks after S101 and before S102:

the mobile terminal sending identity information of a user to the access terminal via the wireless connection; and

the access terminal registering the identity information of the user with the platform apparatus.

It is noted that identity information of a user may include information that is able to uniquely identify an identity of the user, such as an account number or a mobile phone number, in various implementations of the present disclosure. After the identity information of the user is registered, purchase activities of the user (for example, frequency of consumption and types of consumption, etc.) may be tracked, so as to provide better services to the user.

Moreover, it is noted that the registration of the user identity information may be performed at any time, and not limited to be performed in between S101 and S102. Apparently, in other implementations of the present disclosure, the transaction process may be completed using the payment information without registering the user identity information.

A third addition includes broadcasting merchant information. More specifically, S101 may include the following method sub-blocks:

the access terminal broadcasting merchant information; and

the mobile terminal receiving and displaying the merchant information, and the mobile terminal establishing the wireless connection with the access terminal in response to receiving the input indicating user confirmation.

It is noted that in the embodiments of the present disclosure, the merchant information may be information such as a name, an address, a trademark, etc., of a merchant. A better service may be provided to the user by broadcasting the merchant information to the user.

Apparently, in other embodiments of the present disclosure, the mobile terminal may not broadcast the merchant information, but may directly connect to the access terminal in a wireless manner to complete the transaction instead.

As can be seen from the foregoing transaction process, only user identity information and merchant information is exchanged between the user and the merchant, thus ensuring the security of transaction while providing a convenient operation and improving user experience.

Typical application scenarios of the foregoing method may include an instant payment for consumption (for example, a dining consumption payment, a ticket payment, etc.) and a delayed payment for consumption (for example, in a parking lot, karaoke hall, etc.). Examples of these application scenarios are provided hereinafter.

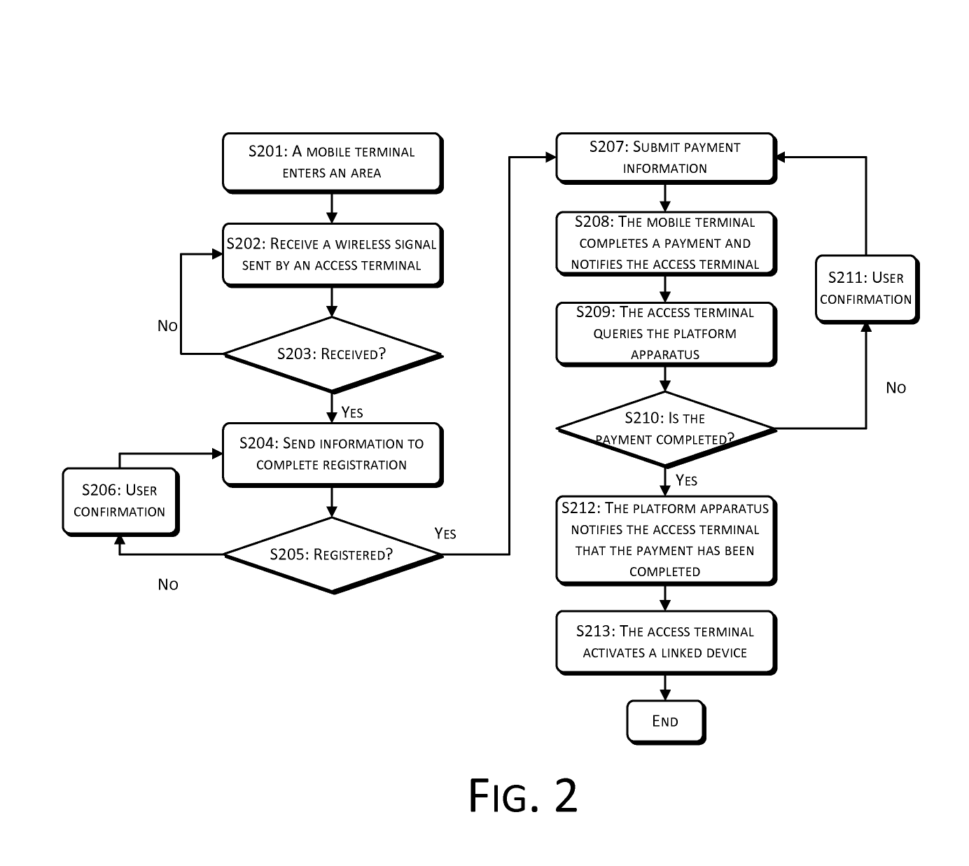

As shown in FIG. 2, in a scenario of an instant consumption payment,

At S201, a user carries a mobile terminal (such as a personal smart phone) enters a payment area (where a size of the area depends on a distance of a wireless communication), and the user opens an application (APP) in the mobile terminal to receive wireless signals (an access terminal of a merchant periodically sends out wireless signals to facilitate communications with users) at S202. In an implementation, the access terminal of the merchant periodically sends broadcast information (which includes information such as a name or address of the merchant), and waits for an access from a user terminal the broadcast information. The user comes to the merchant, and uses the mobile terminal to receive the broadcast information of the merchant at S203. It should be noted that the access terminal of the merchant may not need to broadcast the merchant information in other implementations of the present disclosure.

After the mobile terminal of the user and the access terminal of the merchant successfully connect to each other, the APP in the mobile terminal may be used to automatically complete registration (e.g., the APP may send unique identity information of the user to the access terminal) at S205. In an implementation, upon confirming that the broadcast merchant information is correct, the user clicks on “connect to merchant XXX” in the APP of the mobile terminal, and the mobile terminal of the user sends the unique identity information of the user to the access terminal of the merchant (identity information such as an Alipay™ account number or a mobile phone number), to complete the registration with the merchant. In this way, all activities of the user at the merchant may be identified by the merchant. Apparently, the user may not need to confirm the merchant information at S206, but may directly connect to the access terminal in a wireless manner in other implementations of the present disclosure. Moreover, it is noted that the user may not need to perform registration, but may directly conduct the transaction with the merchant using the payment information.

The access terminal of the merchant automatically sends payment information according to an activity of a user at S207. For example, when a user buys a piece of clothing at the merchant and wants to make a payment, the merchant uses the access terminal of the merchant to send shopping information of the user to a mobile terminal of the user (using wireless Bluetooth in an implementation, for example).

Upon receiving and confirming the payment information, the user uses the mobile terminal to complete the payment at S208. For example, the mobile terminal of the user displays a status of completion of a current consumption at the merchant. After confirming that the payment information is correct, “pay for the current consumption” is clicked on the APP in the mobile terminal to automatically complete a payment process for an associated commodity. The user then uses the mobile terminal to notify the access terminal that the payment has been completed, and the access terminal reports information to a platform apparatus (such as a personal computer or notebook computer) of the merchant at S209.

After the user completes the current consumption at S211, the platform apparatus of the merchant receives information indicating that the current consumption has been completed, and notifies the access terminal of the merchant of this information at S212. In other words, after confirming that the payment is successful, the merchant informs the access terminal that the payment has been completed. In this case, the access terminal check with the user regarding the payment information again, and instructs a linked device to open an electronic door (for a payment scenario such as ticket consumption, etc.) or print a receipt (for a payment scenario such as dining consumption or the like), e.g., a purchase voucher such as an invoice of the current consumption at the same time, to complete the consumption at 213. It is noted that the linked device may not need to be deployed in other implementations of the present disclosure.

The payment process ends.

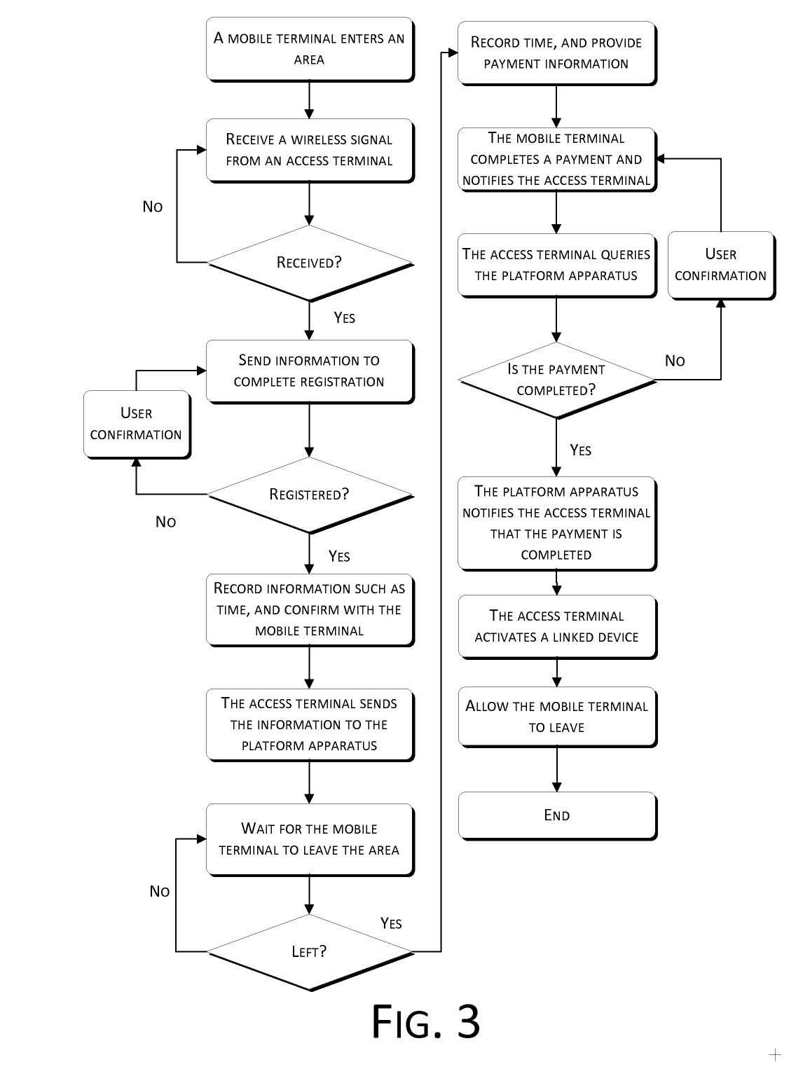

As shown in FIG. 3, in a scenario of delayed consumption payment, the process is basically the same as that in FIG. 2, except that the mobile terminal of the user actively exchanges information with the access terminal of the merchant twice and completes a calculation of a parking fee, for example, based on a time difference therebetween. A payment process thereof is the same as that of the scenario of instant consumption payment. Specifically, after the user enters an area, connects to an access terminal and completes wireless communication for the first time, the access terminal automatically records information of an associated time and an associated place, and does not calculate a fee immediately. When returning to the area after leaving the area for a period of time, the user connects to the access terminal and completes wireless communication again for the second time, the access terminal records a time and a place of the second time, calculates consumption information based on a time difference therebetween, and actively sends the consumption information to the mobile terminal of the user. After the user confirms the consumption, the payment is completed. Subsequent procedures are the same as those described in the foregoing embodiment. For example, in a scenario of charging for parking, the access terminal of the merchant may also have a function of opening a gate to allow the passage of a vehicle into or out of a parking lot, in addition to printing a voucher for a parking fee.

In addition to calculating the time difference, the mobile terminal of the user may also successively connect to access terminals that are disposed at different places in a wireless manner. The access terminal(s) that is/are connected may then calculate consumption information based on a distance between two places, and actively send(s) the consumption information to the mobile terminal of the user. It is noted that other information that is related to final consumption information may further be recorded (for example, which games have been played in a playground) in other implementations of the present disclosure, as long as the final consumption information can be sent to the mobile terminal of the user.

In a consumption process, only personal identity information of a user and information of a merchant are exchanged between the user and the merchant, thus ensuring the security of a transaction. In addition, in the consumption process, both the user and the merchant are able to possess data and record(s) associated with the transaction and a purchase voucher or invoice, thereby ensuring the truthfulness, validity and legality of the consumption process.

It can be understood that the foregoing descriptions are merely exemplary method embodiments. Under various particular scenarios, adjustments and configurations may be performed correspondingly for the mobile terminal, the access terminal, the platform apparatus and the payment server to satisfy various needs based on the needs, and are not limited to the foregoing settings. For example, an instant consumption and a delayed consumption may be combined in a manner that an advance payment is made during a first wireless connection and an additional payment is made or a difference is returned based on an actual cost of consumption during a second wireless connection.

All the method embodiments of the present disclosure may be implemented using software, hardware or firmware. Regardless of whether the present disclosure is implemented using software, hardware or firmware, an instruction code may be stored in any type of computer-accessible storage device (e.g., permanent or temporary, volatile or non-volatile, solid state or non-solid state, fixed or removable media, etc.). Likewise, the storage device may include, for example, a programmable array logic (“PAC”), random access memory (“RAM”), programmable read only memory (“PROM”), read-only memory (“ROM”), electrically erasable programmable ROM (“EEPROM”), a magnetic disk, an optical disk, a digital versatile disc (“DVD”), etc.

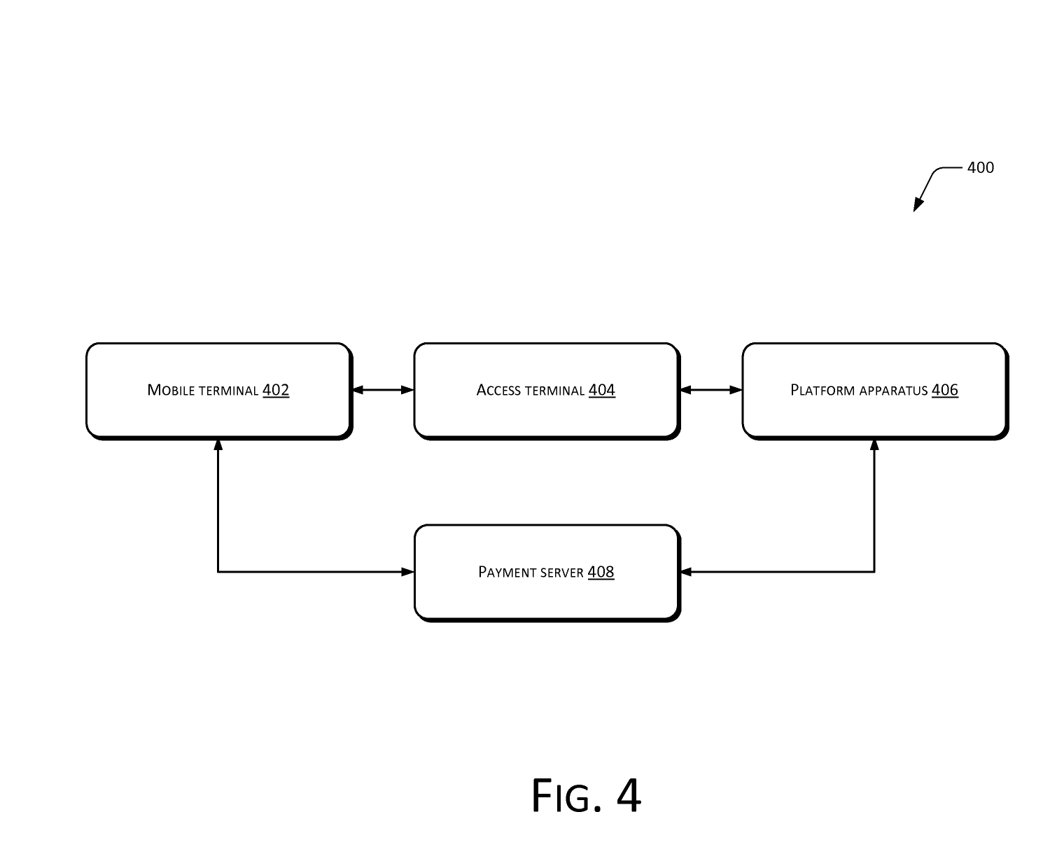

A third embodiment of the present disclosure is related to a system for implementing an electronic payment using a mobile terminal. FIG. 4 is a structural diagram of a system 400 for implementing an electronic payment using a mobile terminal. As shown in FIG. 4, the system 400 for implementing an electronic payment using a mobile terminal may include a mobile terminal 402, an access terminal 404, a platform apparatus 406 and a payment server 408.

The mobile terminal 402 establishes a wireless connection with the access terminal 404, displays payment information that is received from the access terminal 404, interacts with the payment server 408 based on the payment information after receiving an input indicating user confirmation to complete a payment, and notifies the access terminal 404 that the payment has been completed through the wireless connection.

The access terminal 404 establishes the wireless connection with the mobile terminal 402, sends the payment information to the mobile terminal 402 through the wireless connection, and notifies the platform apparatus 406 that the payment has been completed in response to receiving a notification indicating that the payment has been completed from the mobile terminal 402 through the wireless connection.

The platform apparatus 406 interacts with the payment server 408 to confirm a payment completion status of the mobile terminal 402 in response to receiving the notification indicating that the payment has been completed from the access terminal 404.

The payment server 408 completes processing of an electronic payment service.

In an implementation, the access terminal 404 may access only one mobile terminal 402 at a time, so that the access terminal 404 accesses is able to allow an access from one mobile terminal 402 only at a time to ensure the stability and the security of a transaction.

Moreover, it can be understood that the access terminal 404 may also access a plurality of mobile terminals 402 at the same time in some particular application scenarios.

The example electronic payment apparatus 400 includes a mobile terminal 402, an access terminal 404, a platform apparatus 406 and a payment server 408. The mobile terminal 402 exchanges payment information with the access terminal 404 via a wireless connection, and the platform apparatus 406 confirms a payment completion status. In an entire process of a transaction, a user and a merchant do not need to exchange passwords, thus ensuring the security of the transaction. Moreover, a fast payment system based on a wireless technology and a mobile terminal is established, which maximizes the utilization of existing resources of the user without restriction.

Application scenarios of the foregoing system for implementing an electronic payment using a mobile terminal may include an instant consumption payment and a delayed consumption payment.

In an instant payment for consumption, in response to a mobile terminal establishing a wireless connection with an access terminal, the access terminal may immediately send related payment information to the mobile terminal.

In a delayed payment for consumption, an access terminal is used for recording a first time and/or a first place when or after a mobile terminal establishes a first wireless connection with the access terminal. Furthermore, the access terminal records a second time and/or a second place when or after the mobile terminal establishes a second wireless connection with the access terminal, and sends payment information to the mobile terminal via a wireless connection according to information of recorded times and/or places.

The first embodiment is a method embodiment corresponding to the present embodiment, and the present embodiment may be implemented in combination with the first embodiment. Relevant technical details mentioned in the first embodiment are also applicable to the present embodiment, and are not repeatedly described herein to avoid redundancies. Correspondingly, relevant technical details mentioned in the present embodiment may also be applicable to the first embodiment.

A fourth embodiment of the present disclosure is related to a system for implementing an electronic payment using a mobile terminal. In an implementation, the fourth embodiment includes a number of additions over the third embodiment.

In an implementation, a first addition may include further using a linked device in a transaction process. In an implementation, the system 400 may further include a linked device 410.

In an implementation, the platform apparatus 406 may further be configured to notify the access terminal 404 that the payment has been completed in response to confirming that the mobile terminal 402 has completed the payment, and notify the access terminal 404 that the payment has not been completed in response to confirming that the mobile terminal 402 has not completed the payment.

In an implementation, the access terminal 404 may further be configured to activate the linked device 410 after receiving a notification indicating that the payment has been completed from the platform apparatus 406, and turn off the linked device 410 after receiving a notification indicating that the payment has not been completed from the platform apparatus 406.

In a transaction process, the linked device 410 may be used to implement functions such as printing a receipt or voucher of a transaction after an electronic payment is completed, so that both a user and a merchant are able to possess data and records associated with the transaction, thereby ensuring the truthfulness, validity and legality of the electronic transaction process.

Moreover, it can be understood that the linked device 410 may need not to be deployed in other implementations of the present disclosure.

In an implementation, a second addition may include performing a registration using identity information of a user.

In an implementation, the mobile terminal 402 may further be configured to send identity information of a user to the access terminal 404 via the wireless connection after establishing the wireless connection with the access terminal.

In an implementation, the access terminal 404 may further be configured to perform a registration using the identity information of the user that is received from the mobile terminal 402 in the platform apparatus 406.

After the registration is performed using the identity information of the user, purchase activities of the user (for example, frequency of consumption and types of consumption) may be tracked to provide better services to the user.

Moreover, it can be understood that a transaction process may be completed using payment information without registering identity information of a user in other implementations of the present disclosure.

In an implementation, a third addition may include broadcasting merchant information.

In an implementation, the access terminal 404 broadcasts merchant information. The mobile terminal 402 receives the merchant information from the access terminal 404 and displays the merchant information, and establishes the wireless connection with the access terminal after receiving an input indicating user confirmation.

A better service may be provided to a user by broadcasting information of a merchant to the user.

Moreover, it can be understood that the merchant information may not need to be broadcasted, and the mobile terminal 402 may wireless connect with the access terminal 404 to complete a transaction directly in other implementations of the present disclosure.

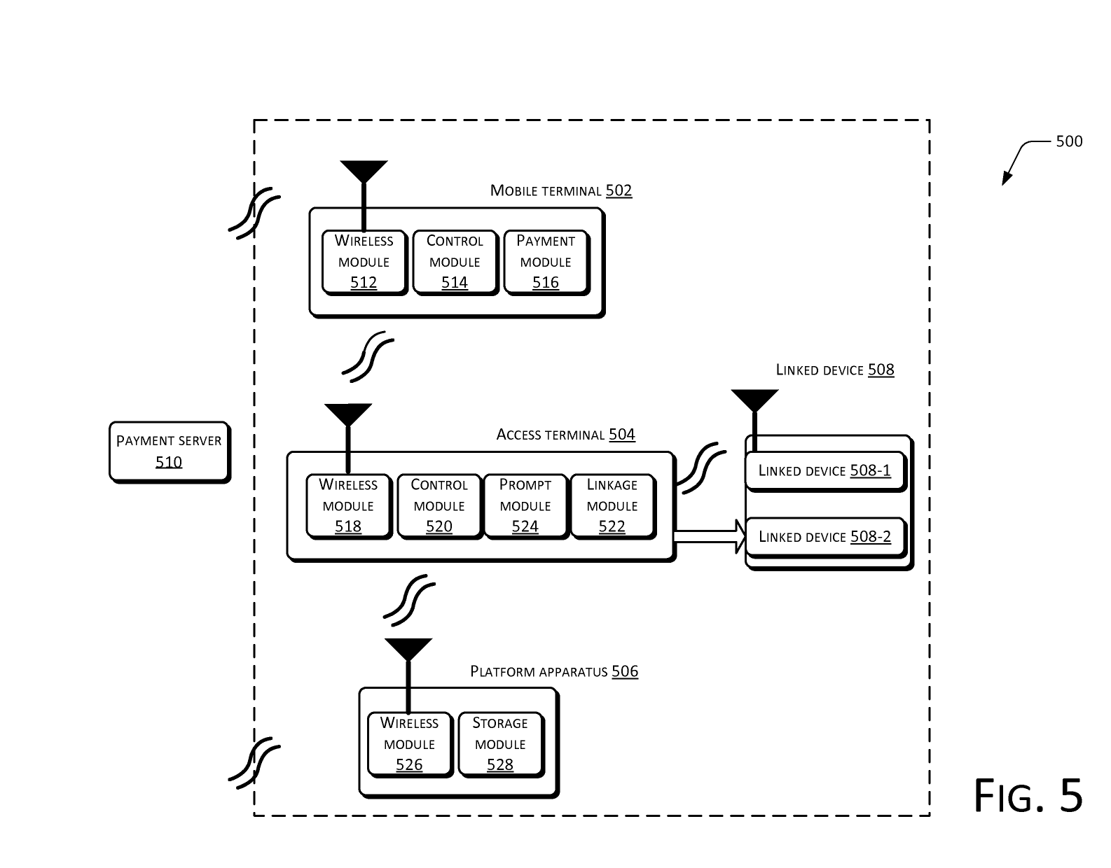

FIG. 5 shows an example system 500 for implementing an electronic payment using a mobile terminal. In an implementation, the system 500 may include a mobile terminal 502, an access terminal 504, a platform apparatus 506, linked devices 508 (e.g., a linked device 508-1 and a linked device 508-2), and a payment server 510.

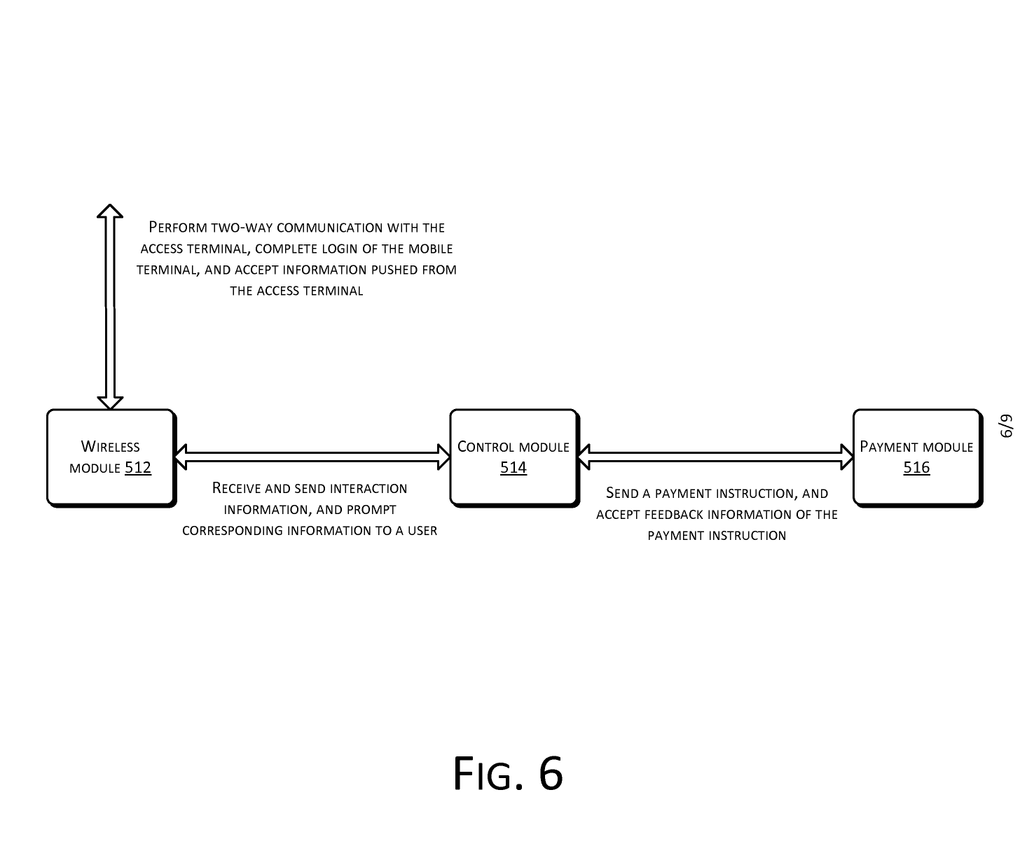

As shown in FIGS. 5 and 6, the mobile terminal 502 may include a wireless module 512 (which implements accessing to the system and exchanging information), a control module 514 (which analyzes, executes, and prompts interaction information), and a payment module 516 (which implements a payment function). In an implementation, the mobile terminal 502 enables the wireless module 512 to read the control module 514 that has passed identity authentication, and exchanges information with the access terminal 504 to achieve registration and login. The payment module 516 accepts the information and an instruction from the control module 514 to complete the payment function, and sends corresponding payment information to the control module 514. In addition, the control module 514 may also push prompt information of the access terminal 504 to a user to help the user to complete the payment function. It can be understood that the mobile terminal 502 may be implemented as a smart phone that is commonly used in people's daily lives. The wireless module 512 may be a standard functional module configured in the smart phone. The control module 514 may be APP software (which supports the functions), and the payment module 516 may be payment software for the mobile phone. Apparently, in other implementations of the present disclosure, the mobile terminal 502 may alternatively be a tablet computer, a notebook computer, or another portable device.

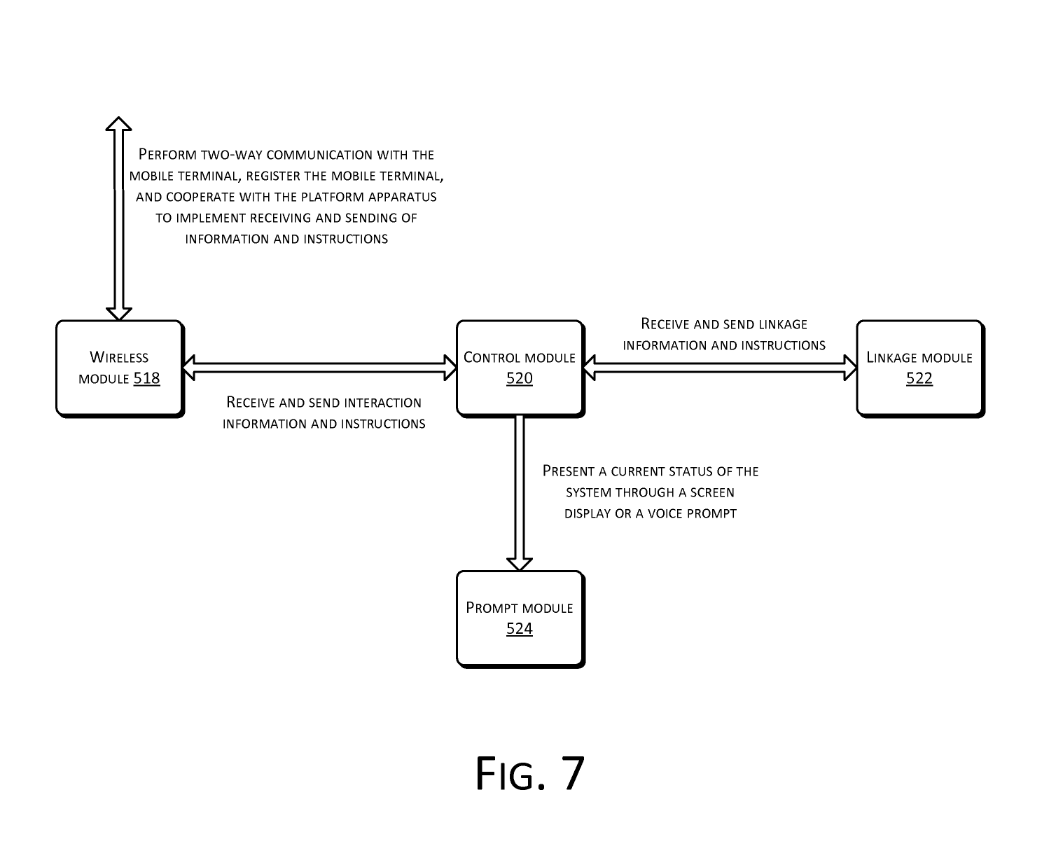

As shown in FIGS. 5 and 7, the access terminal 504 may include a wireless module 518 (which implements two-way communication with the mobile terminal 502 and cooperates with the platform apparatus 506 to implement receiving and sending of information and instructions), a control module 520 (which receives information or instructions from the mobile terminal 502 and the platform apparatus 506, and distributes the information or the instructions to a linkage module 522 and a prompt module 524), the linkage module 522 (which provides information or an instruction to the linked device 506 to complete a particular function), and the prompt module 524 (which informs the user of a current status of the system 500 through a screen display or a voice prompt). In an implementation, the access terminal 504 provides information to the platform apparatus 506 after registering the mobile terminal 502, and distributes the information or the instructions to the linkage module 522 and the prompt module 524 during a process of exchanging information with the mobile terminal 502 to inform the user of the current status of the system 500. In an implementation, the platform apparatus 506 may include a wireless module 526 and a storage module 528.

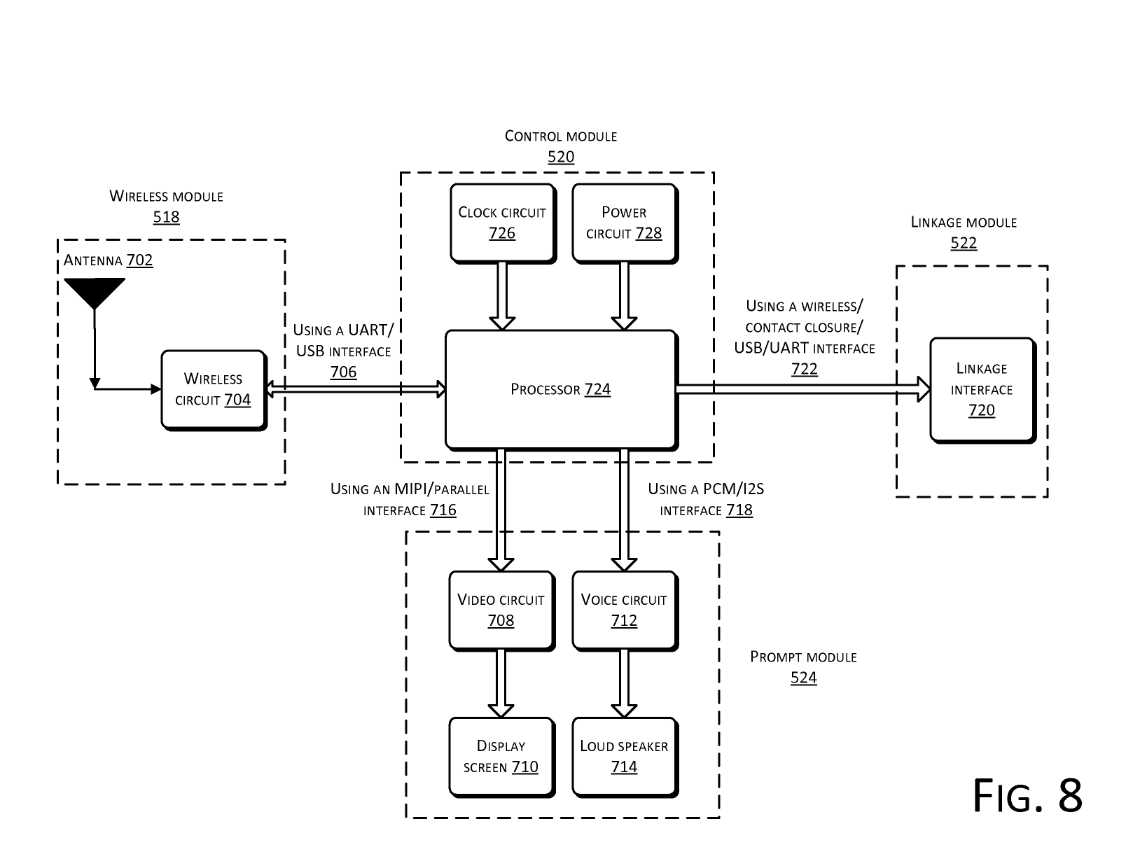

FIG. 8 shows an example circuit implementation of the access terminal 504. As shown in FIG. 8, the wireless module 518 includes an antenna 702 and a wireless circuit 704, and is connected to the control module 520 via a universal asynchronous receiver/transmitter (“UART”) interface or a universal serial bus (“USB”) interface 706. The prompt module 524 includes a video circuit 708, a display screen 710, a voice circuit 712, and a loudspeaker 714. The video circuit 708 is connected to the control module 520 via a mobile industry processor interface (“MIPI”) or a parallel interface 716. The voice circuit 712 is connected to the control module 520 via a pulsed code modulation (“PCM”) interface or an inter-IC sound (12S) bus interface 718. The linkage module 524 includes a linkage interface 720 and is connected to the control module 520 via a wireless, contact closure, USB, or UART interface 722. The control module 520 includes a processor 724, a clock circuit 726, and a power circuit 728. However, one of ordinary skill in the art should understand that the foregoing modules may be implemented using other circuit structures, and are not limited to the foregoing configuration.

FIG. 5 shows two linked devices 508 for implementing particular functions (a linked device 508-1 and a linked device 508-2). In various implementations of the present disclosure, a linked device 508 may include an apparatus such as a door access controller, a switch button, a printer, etc., and a particular function that is implemented may include a function of door opening and admission after successful charging, printing a transaction receipt or voucher (to ensure the truthfulness, validity and legality, and to provide a record for examination), etc. However, it can be understood that the linked device(s) may not be an essential functional device of the system 500. In addition, in various implementations of the present disclosure, one or more linked devices may be provided according to needs, and the number of linked devices is not limited to two as shown in FIG. 5.

The platform apparatus 506 and the access terminal 504 complete an exchange of information, and locally store or upload the information. In an implementation, after receiving information reported by the access terminal 504, the platform apparatus 506 may determine whether an associated transaction has been completed, and send payment information to the access terminal 504 for completing subsequent actions. The platform apparatus 506 may include a personal computer, a notebook computer, etc., that is commonly used in people's daily lives.

As can be seen from the above, the system 500 is able to maximize the utilization of existing resources of a user without restriction.

It can be understood that the foregoing description is merely an example of the disclosed system, and apparatuses may be added or removed based on a real situation to meet particular needs therein.

The second embodiment is a method embodiment corresponding to the present embodiment, and the present embodiment can be implemented in combination with the second embodiment. Relevant technical details mentioned in the second embodiment are also applicable to the present embodiment, and are not repeatedly described herein to avoid redundancies. Correspondingly, relevant technical details mentioned in the present embodiment may also be applicable to the second embodiment.

In short, the present disclosure achieves a fast payment method that involves a mobile terminal, an access terminal, a platform apparatus and a payment server based on a wireless technology and a payment terminal, and establishes a fast payment system, thus maximizing the utilization of existing resources of a user without restriction while ensuring the security of a transaction.

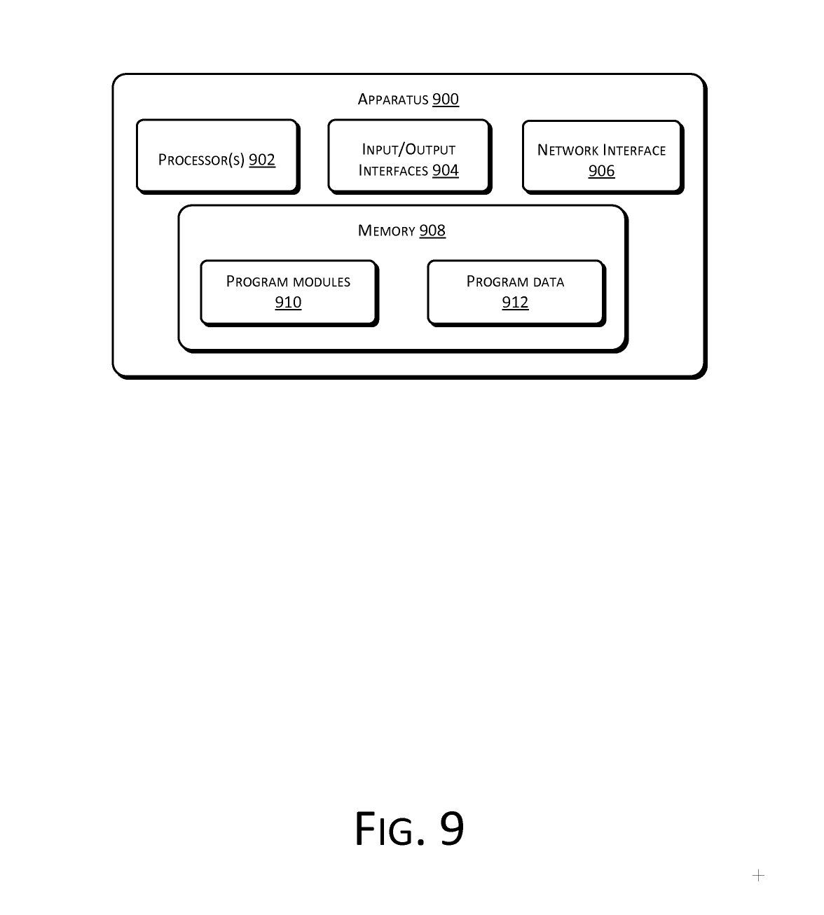

FIG. 9 shows an example apparatus 900, such as the terminals, apparatuses, devices and systems as described in FIGS. 4-8 in further detail. In an implementation, the apparatus 900 may include, but is not limited to, one or more processors 902, an input/output interface 904, a network interface 906, and memory 908.

The memory 908 may include a form of computer readable media, e.g., a non-permanent storage device, random-access memory (RAM) and/or a nonvolatile internal storage, such as read-only memory (ROM) or flash RAM. The memory 908 is an example of computer readable media.

The computer readable media may include a permanent or non-permanent type, a removable or non-removable media, which may achieve storage of information using any method or technology. The information may include a computer-readable command, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

The memory 908 may include program modules 910 and program data 912. Depending on which terminal, apparatus, device or system that the apparatus 900 is referred to, the program modules 910 may include one or more modules, circuits and/or devices, etc., as described above. Details of these modules and circuits can be found in the foregoing description and are therefore not redundantly described herein.

It should be noted that relational terms described herein, such as “first” and “second”, etc., are used solely to distinguish one entity or operation from another entity or operation without necessarily requiring or implying any existence of such relationship or ordering between these entities or operations in reality. Moreover, terms such as “comprise”, “include” and any other variants thereof are intended to cover a non-exclusive inclusion. A process, method, product or device that includes a series of elements not only includes those elements, but also includes other elements that are not explicitly listed, or further includes elements that already existed in such process, method, product or device. In a condition without further limitations, an element defined by a phrase “include a/an . . . ” does not exclude any other similar elements from existing in the process, method, product or device.

Although the present disclosure has been illustrated and described using some exemplary embodiments of the present disclosure, one of ordinary skill in the art should understand that various changes may be made to the forms and details of these embodiments without departing from the spirit and scope of the present disclosure.

What is claimed is:

1. A method implemented by a mobile terminal, the method comprising:
establishing a wireless connection with an access terminal;
receiving payment information from the access terminal through the wireless connection;
displaying the payment information in a display of the mobile terminal;
communicating with a payment server according to the payment information in response to receiving an input indicating user confirmation to complete a payment; and
notifying the access terminal that a payment has been completed through the wireless connection to cause the access terminal to notify a platform apparatus that the payment has been completed and to enable the platform apparatus to communicate with the payment server to confirm a payment completion status of the mobile terminal.

2. The method of claim 1, further comprising:
establishing a first wireless connection with the access terminal to cause the access terminal to record one or more of a first time or a first place at which the first wireless connection takes place; and
establishing a second wireless connection with the access terminal to cause the access terminal to record one or more of a second time or a second place at which the second wireless connection takes place; and
receiving the payment information from the access terminal through the wireless connection based at least in part on information of one or more of the recorded first time and the record second time, or the recorded first place and the recorded second place.

3. The method of claim 1, further comprising:
notifying, via the platform apparatus, the access terminal that the payment has been completed to cause the access terminal to activate a linked device in response to confirming that the mobile terminal has completed the payment; or
notifying, via the platform apparatus, the access terminal that the payment has not been completed to cause the access terminal to turn off the linked device in response to confirming that the mobile terminal has not completed the payment.

4. The method of claim 1, further comprising sending user identity information to the access terminal through the wireless connection to cause the access terminal to register the user identity information with the platform apparatus.

5. The method of claim 1, wherein establishing the wireless connection with the access terminal comprises:
receiving and displaying merchant information that is broadcasted by the access terminal; and
establishing the wireless connection with the access terminal in response to receiving an input indicating confirmation from a user.

6. The method of claim 1, wherein the access terminal is allowed to access only one mobile terminal at a time.

7. A system comprising: a mobile terminal, an access terminal, a platform apparatus and a payment server, wherein:
the mobile terminal establishes a wireless connection with an access terminal, displays payment information that is received from the access terminal, communicates with the payment server based at least in part on the payment information after receiving an input indicating user confirmation to complete a payment, and notifies the access terminal that the payment has been completed through the wireless connection;
the access terminal establishes the wireless connection with the mobile terminal, sends the payment information to the mobile terminal through the wireless connection, and notifies the platform apparatus that the payment has been completed in response to receiving a notification indicating that the payment has been completed from the mobile terminal through the wireless connection;
the platform apparatus communicates with the payment server to confirm a payment completion status of the mobile terminal in response to receiving the notification indicating that the payment has been completed from the access terminal; and
the payment server completes processing of the payment.

8. The system of claim 7, wherein the access terminal further records a first time and/or a first place when the mobile terminal establishes a first wireless connection with the access terminal, records a second time and/or a second place when the mobile terminal establishes a second wireless connection with the access terminal, and sends the payment information to the mobile terminal through the wireless connection based at least in part on information of recorded times and/or places.

9. The system of claim 7, further comprising a linked device, wherein:
the platform apparatus is further configured to notify the access terminal that the payment has been completed in response to confirming that the mobile terminal has completed the payment, and notify the access terminal that the payment has not been completed in response to confirming that the mobile terminal has not completed the payment; and
the access terminal is further configured to activate the linked device in response to receiving a notification indicating that the payment has been completed from the platform apparatus, and turn off the linked device in response to receiving a notification indicating that the payment has not been completed from the platform apparatus.

10. The system of claim 9, wherein the linked device comprises one or more of a door access controller, a switch button or a printer.

11. The system of claim 9, wherein the linked device is configured to cause door opening and admission after successful charging or print a transaction receipt or voucher after the payment has been completed.

12. The system of claim 7, wherein:
the mobile terminal further sends user identity information to the access terminal through the wireless connection after establishing the wireless connection to the access terminal; and
the access terminal further registers the user identity information that is received from the mobile terminal with the platform apparatus.

13. The system of claim 7, wherein:
the access terminal further broadcasts merchant information; and
the mobile terminal further receives the merchant information from the access terminal, displays the merchant information, and establishes the wireless connection with the access terminal after receiving an input indicating user confirmation.

14. The system of claim 7, wherein the access terminal is allowed to access only one mobile terminal at a time.

15. One or more computer-readable media storing executable instructions that, when executed by an access terminal comprising one or more processors, cause the access terminal to perform acts comprising:
establishing a wireless connection with a mobile terminal;
sending payment information to the mobile terminal through the wireless connection to cause the mobile terminal to display the payment information;
receiving a notification that a payment has been completed from the mobile terminal through the wireless connection; and
notifying a platform apparatus that the payment has been completed to cause the platform apparatus to communicate with the payment server to confirm a payment completion status of the mobile terminal.

16. The one or more computer-readable media of claim 15, the acts further comprising:
establishing a first wireless connection with the mobile terminal and recording one or more of a first time or a first place at which the first wireless connection takes place; and
establishing a second wireless connection with the mobile terminal and recording one or more of a second time or a second place at which the second wireless connection takes place; and
sending the payment information to the mobile terminal through the wireless connection based at least in part on information of one or more of the recorded first time and the record second time, or the recorded first place and the recorded second place.

17. The one or more computer-readable media of claim 15, the acts further comprising:
receiving a notification indicating that the mobile terminal has completed the payment from the platform apparatus; and
activating a linked device in response to receiving the notification indicating that the mobile terminal has completed the payment.

18. The one or more computer-readable media of claim 15, the acts further comprising:
receiving a notification indicating that the mobile terminal has not completed the payment from the platform apparatus; and
turning off a linked device in response to receiving the notification indicating that the mobile terminal has not completed the payment.

19. The one or more computer-readable media of claim 15, the acts further comprising:
receiving user identity information from the mobile terminal through the wireless connection;
registering the user identity information with the platform apparatus.

20. The one or more computer-readable media of claim 15, the acts further comprising broadcasting merchant information to the mobile terminal to cause the mobile terminal to display the merchant information to a user for confirmation prior to establishing the wireless connection.
